(19) United States
(12) Patent Application Publication
(10) Pub. No.: US 2011/0181047 A1
(43) Pub. Date: Jul. 28, 2011

(54) EOLIC CONVERTER TOWER

(76) Inventor: Flavio Francisco Dulcetti Filho, Belem, Pa (BR)

(21) Appl. No.: 13/054,791

(22) PCT Filed: Jul. 25, 2008
(86) PCT No.: PCT/BR2008/000218

§ 371 Date: Apr. 12, 2011

(30) Foreign Application Priority Data
Jul. 16, 2008 (BR) PI080335-8

(51) Int. Cl. F03D 9/00

(52) U.S. Cl. 290/55

(57) ABSTRACT

The present invention relates to a eolic converter tower (1) having an innovative concept wherein a rotary megastructure made of metal or other materials slides horizontally around a vertical reinforced concrete megatower having several levels and means by which these levels can rotate under the force of the wind and transmit this force to a steering wheel (52) and rack (60) assembly, which in turn transmits the force to several generator (38) sets, transforming wind energy into high-power electric energy.

### FIELD OF APPLICATION

The present invention is applied in large-scale generation of electrical power, wherein wind energy is converted into controlled, rotational mechanical power usable for driving electrical power generation equipment and rotors in general, with regulated power output and at a rotation speed more stable than that provided by regular wind energy converters, regardless of wind speed.

### PRIOR ART

The present invention is an evolvement of the invention disclosed in the international application PCT/BR2006/000260 published as WO 2007/065234 A2 and utilizes the same aerodynamic principles to harness wind energy as disclosed in said international application.

The international application above describes a wind energy converter with an unique system for harnessing wind energy, consisting of a set of rectangular panels that drive the rotary assembly on the drive side and the panels been in horizontal position by the wind force itself on the passive side.

This assembly has a support system consisting of a single mast secured to the ground, with a rotary tip at the top of the mast, which is supported by bearings and incorporates horizontal arms for supporting the aerodynamic wind power harnessing panels, forming a single rotary assembly that drives the electrical power generator below.

Although the previous invention disclosed significant improvements compared to conventional turbine converters, the tower proposed herein provides a means of utilizing this same wind power harnessing technology for mega-structure applications. The concept disclosed affords greater ease of construction, operation and transportation of materials by introducing smaller and lighter modular components, by consequence, providing the capability to build structures substantially larger in size, without the preoccupation in how to build a 200 high meters rotary cylindrical vertical hollow cover, which in the present invention are replaced by a mixed structure consisting of a fixed reinforced concrete portion and a lighter rotary structure manufactured of metal, metal alloys or fiber. Through the present invention, greater dimensions may be achieved without structural or logistical impediments, such as the need to transport large, long-spanning components.

Through this new constructive concept, a single tower can be built such that it is capable of producing as much or more torque than that produced by an entire farm of turbine converters, representing a significant improvement in terms of investment cost versus generated power, making this concept a competitive and low-cost source of energy.

Additionally, in certain regions there is a lack of physical space to build large wind converters farms occupying thousands of square-meters of land, making it necessary to build wind converters farms offshore. Through the present invention, however, an area equivalent to that occupied by a large residential or office building will be sufficient to replace the thousands of square meters required for conventional wind converters farms.

### BRIEF DESCRIPTION OF THE INVENTION

The eolic (wind energy) converter tower disclosed in the present invention is designed for large-scale electrical power generation, such as 100 MW, depending on the size of the wind harnessing panels, the height of the tower and wind speed.

The present invention is a mixed structure consisting of an internal reinforced concrete structure supporting an external rotary structure having pillars, metallic beams, arms and aerodynamic panels.

The height of the concrete part of the tower disclosed in the present invention may, for instance, range from 100 to 400 m, incorporating a number of platform levels equal to the number of aerodynamic panels, with one level every 5 or 10 meters, for instance (depending on the height of the aerodynamic wind harnessing panels).

The reinforced concrete part incorporates, at its first three levels, a rectangular or square cross-section base building.

The ground floor of said building has an entrance providing access to the stairs and elevator and side ramps providing access to the first floor, allowing cargo vehicles and heavy machinery to enter.

The elevator and stairs provide access to all platform levels, affording access to every level of the rotary and sliding structures.

The elevator and stairs do not have access to the generation room at the first level due to the rotary circle formed by the moving pillars extending from each platform to the steering wheel and rack used to drive the generator assembly.

The first level contains the tower's generation, control and automation room.

The second level serves as the ceiling of the generation room and a transition (passageway) for the external rotary structure.

The upper next part of the tower is circular in cross-section and consists of reinforced concrete platform levels, the uppermost of which contains the elevator machine room, a fire main water tank and an oil tank for lubricating and recirculating oil to the sliding elements of the moving structure. On top of the uppermost level sits a horizontal, rectangular cross-section beam supporting a monorail and wire rope cables for suspending the maintenance chairs and/or work platforms to be used by maintenance personnel when servicing or repairing the rotary structure and aerodynamic panels.

At the center of every platform have an elevator shaft, a stairs and concrete pillars forming a circle such that the circular platform has sufficient overhang to allow the freely rotation of the moving pillars connecting internal beams.

Sliding elements are fastened to the outer edge of every platform to support the four metallic moving pillars. These four moving pillars are spaced 90° each other and are interconnected by eight beams arranged in two 4-beam levels for every interval between successive platforms, providing perfect stability between the moving pillars.

Despite the magnitude of this mega-project, if the cost of this concrete structure (assuming, for example, that the circular tower platforms measure 15 m in diameter and the first three square cross-section levels measure 50×50 m) is compared to that of a residential building of the same height, the cost of the former is about one fourth or less of the latter.

Unlike the cylindrical vertical hollow cover disclosed in prior art, the rotary metal structure disclosed herein will not occupy the entire cross-sectional area of the tower.

It will instead consist of four metallic mobile pillars at each level, supported by circular sliding systems fastened to the edges of the platforms.

The four metallic pillars at each level are interconnected by two sets of four trussed girders for greater stability.

The supporting arms of the bascule aerodynamic panels are fastened to the mobile pillars.

In the present invention, the mobile metallic pillars of supporting of the horizontal arms of the aerodynamic panels run down the full height of the tower to the electrical power generation platform located on the first floor, where they connect to the steering wheel and rack assembly. The pillars are structurally interconnected by beams along the entire tower to transmit the torque produced at each level. As an alternative, 4 mobile pillars may be used for every four panel levels. For a structure with 16 panel levels, 16 columns would be required to transmit the torque, depending on the wind harnessing area established.

This system provides the capability to increase the wind capture area of a single tower almost infinitely by increasing the number and size of the aerodynamic wind harnessing panels, without the structural or aerodynamic interaction limitations of the conventional methods of generating wind power and at much lower construction costs (investment per generated megawatt).

The resulting low-cost energy makes this system competitive and even less costly than conventional power generation methods such as hydroelectric plants, thermoelectric plants, nuclear plants, etc., eliminating the disadvantage, in terms of cost and economic feasibility, of employing wind power, which in many regions requires government subsidies or allocated markets.

The system of the present invention produces rotational mechanical power with a minimum energy efficiency of 90% considering the total area on the drive side of the tower, said efficiency increasing with wind speed. In addition to, and even more important than, this high efficiency, the system provides the capability to increase the amount of torque produced at each level by increasing the size of the panels without limitations. A single driveshaft can utilize huge wind capture areas, allowing the system to be used even in regions where predominantly low wind speeds occur.

A rotation sped control system is provided so that electrical power is produced with the same stability afforded by conventional large-scale generation systems, with no variations, transients or noise. In areas where wind speed is insufficient during some periods, an internal combustion engine with controlled injection or, for areas where another non-wind power source is available, an electric motor is coupled to, and constantly rotates in unison with, the generator shaft to avoid the energy consumption required to start the motor. When the electronic rotation monitoring system is unable to offset the decreasing rotation caused by decreasing wind speeds, the motor kicks in with no perceptible interruptions or fluctuation, making the present invention a hybrid system capable of reducing the amount of power required from non-wind sources by 90%.

The tower of the present invention is not required to be pointed windward, as it will always rotate in a preset direction: clockwise when the panels are designed to lock in the clockwise direction, or counterclockwise when the panels are designed to lock in the counterclockwise direction. The tower also incorporates a system for protection against gales and storms, in which coils situated at the upper stoppers are energized in the feathered position, so that all the panels are kept feathered out of the wind by the force of the electromagnet.

In the present method of harnessing wind power, the rotary assembly is rotated by the wind pressure acting on the aerodynamic panels, which rotate horizontally, describing circles.

Instead of scoops or turbine blades; the present invention utilizes aerodynamic panels consisting of rectangular or square plates with flat surfaces or louvers, negligible in thickness, manufactured of extremely light materials capable of withstanding the pressure of the wind, or of heavier materials, but in the latter case using counter weights so that the relative weight for feathering purposes remains small, resulting in extremely low feathering losses. Feathering losses are lower than 1%, as shown in graph 1, generated based on the table below. The same graph shows that the loss caused by the leading edges of the feathered panels is about 1%, varying with the size of the aerodynamic panels.

TABLE 1
The table below shows the relationship between wind speed, in meters per second, and the
total amount of torque produced by each aerodynamic panel, in Kgf, and the relationship
between wind speed, in meters per second, and the efficiency with which the force of the
wind (in Kgf) is transformed into rotational mechanical power, considering the total feathering
loss and the aerodynamic drag on the panel when on the passive side.

| Aerodynamic | Wind | Wind | Wind | Total driving force | | Resulting force | |
|---|---|---|---|---|---|---|---|
| panel area | Speed | Speed | Force | produced by aero- | Furling | produced by aero- | Efficiency |
| 10 m × 30 m² | (m/s) | (Km/h) | (Kg/m²) | dynamic panel | Loss | dynamic panel (Kgf) | (%) |
| 300 | 1 | 3.6 | 2.52 | 756 | 7.56 + 2 | 746.44 | 98.73 |
| 300 | 2 | 7.2 | 5.04 | 1512 | 15.12 + 2 | 1494.88 | 98.87 |
| 300 | 3 | 10.8 | 7.62 | 2286 | 22.86 + 2 | 2261.14 | 98.91 |
| 300 | 4 | 14.4 | 10.08 | 3024 | 30.24 + 2 | 2991.76 | 98.93 |
| 300 | 5 | 18.0 | 12.60 | 3780 | 37.8 + 2 | 3740.20 | 98.95 |
| 300 | 6 | 21.6 | 15.12 | 4536 | 45.36 + 2 | 4488.64 | 98.96 |
| 300 | 7 | 25.2 | 17.99 | 5397 | 53.96 + 2 | 5341.04 | 98.96 |
| 300 | 8 | 28.2 | 20.16 | 6048 | 60.48 + 2 | 5985.52 | 98.97 |
| 300 | 9 | 32.4 | 22.68 | 6804 | 68.04 + 2 | 6733.96 | 98.97 |
| 300 | 10 | 36.0 | 25.20 | 7560 | 75.60 + 2 | 7482.40 | 98.97 |
| 300 | 11 | 39.6 | 27.72 | 8316 | 83.16 + 2 | 8230.84 | 98.98 |
| 300 | 12 | 43.0 | 30.24 | 9072 | 90.72 + 2 | 8979.28 | 98.98 |

The rotary system has two different sides in relation to the direction of the wind: the drive side, where the panels move leeward and are maintained vertical by stoppers, producing the driving force that turns the vertical shaft; and the passive side, in which the panels move windward and are feathered (tilted to the horizontal position) under the force of the wind such that they offer the least possible resistance to the wind and ensure that the force produced on the drive side is transmitted to the vertical shaft with utmost efficiency. The resulting force applied to the vertical shaft is therefore the force produced on the drive side minus the feathering loss on the passive side, which defines the efficiency of the drive panels. There is a small additional loss related to the aerodynamic drag on the leading edge of the feathered panel, which ranges around the value of 1% depending on the size of the aerodynamic wind harnessing panels.

The direction of tower rotation may be clockwise or counterclockwise, depending on the side (left or right) on which the stoppers are set to keep the panels in vertical position when moving downwind and feathered when moving upwind.

When the panel stopper is set such that the panels are kept vertical on the left side of the tower (viewed upwind of the tower), the system rotates clockwise, and vice-versa.

The aerodynamic wind harnessing panels are suspended on threaded hinges hanging on threaded horizontal shafts, which in turn are supported by the structural arms of each level's rotary structure. The rotary force produced at each level is interconnected, forming a single rotary assembly, and the panels at the different levels are staggered so that the assembly is perfectly balanced, as shown in the figures.

The top supporting hinges allow the panels to tilt up a quarter of a turn (90° from the vertical position to the horizontal position) under the force of the wind.

The horizontal shaft supporting the panel hinges can be turned by a servomotor fastened to the horizontal arm near the point where the horizontal arm is joined to the rotary pillar, so that the aerodynamic panels can be shifted nearer to or further from the tower when there is a change in wind speed, in order to control the rotation speed of rotary assembly.

When moving downwind, the panels are kept vertical and produce torque, and when moving upwind the panels are tilted up to a near horizontal (or feathered) position (tilting slightly downwards so the aerodynamic lift will not impede the panel from returning to the vertical position), resulting in minimal aerodynamic drag.

The tower of the present invention has panels that utilize the force of the wind alone to move between the vertical (drive) and feathered (passive) position, depending on their position in relation to the direction of the wind, there being no linkage or any other mechanical device between the drive (vertical) panels and the passive (feathered) panels, thereby avoiding the aerodynamic drag caused by gusts of wind, turbulence or asymmetric wind force.

In the case of megaprojects, with arm spans as large as, for example, 50 to 100 meters, the aerodynamic panels are subdivided into smaller parts, each measuring, for example, 5 meters, to prevent the aerodynamic drag effects mentioned in the paragraph above. Likewise, every 5-meter panel module is equipped with a servomotor that opens or closes the panel louvers in order to increase or decrease the wind energy harnessing area as necessary.

The panel concept of this invention is such that the wind pressure on the drive side is converted to torque with a high level of efficiency, that is, with minimal feathering loss. As an example, a single panel measuring 100 m in length by 10 m in height, exposed to a wind speed of only 3 m/s, would generate 7 tons of pressure on the drive side, while consuming only 120 kg on the feathering side, representing a loss of less than 2%. A tower with 16 panel levels would generate 112 tons of torque, while a tower with a 3-blade turbine measuring 80 m in diameter produces only 1.7 tons.

The present tower therefore delivers high conversion efficiency and can be used for large-scale, electrical power generation.

In addition, the present invention has the advantage of being horizontally arranged, so that it is not affected by abrupt changes in wind direction, such as gusts of wind or turbulence, and does not require any adjustment or repositioning when the wind changes direction.

The horizontal rotation levels are installed one on top of the other as interconnected, staggered modules.

Every level has four horizontal structural members supporting the aerodynamic panels, spaced 90° apart.

These arms are joined to metallic pillars that slide on and are secured to sliding elements on the circular edges of the platforms.

These pillars have “L” brackets allowing the pillar to move on a “U” rail or other ceramic sliding elements. The sliding rails are mounted to the platform slabs at all levels (from top to bottom).

Every horizontally rotating level is connected to the lower-next rotation level all the way to the 1^{st} story of the base building, where the rotation produced by the entire rotating metallic structure is transmitted to the steering wheel and rack assembly, which in turn transmits the rotation to the generator set(s).

The system is equipped with servomotors that automatically extend or retract the aerodynamic panels to increase or decrease the angular velocity of the rotary system in response to changing wind speeds. This is controlled by an intelligent control system consisting of computers, RPM sensors, anemometers, megawatt meters and other measuring devices, which offsets wind speed variations by extending or retracting the aerodynamic panels and increasing or decreasing the wind capture area through servomotors that open or close the louvers forming the aerodynamic wind harnessing surfaces of the panels.

For a better understanding of the present invention, an embodiment of the invention is described in detail with reference to the accompanying drawings, merely as an illustration and not as a limitation on the scope of the invention.

### DESCRIPTION OF THE FIGURES

FIG. 01—Front view of the tower, illustrating the full tower, with its various levels and the base building;

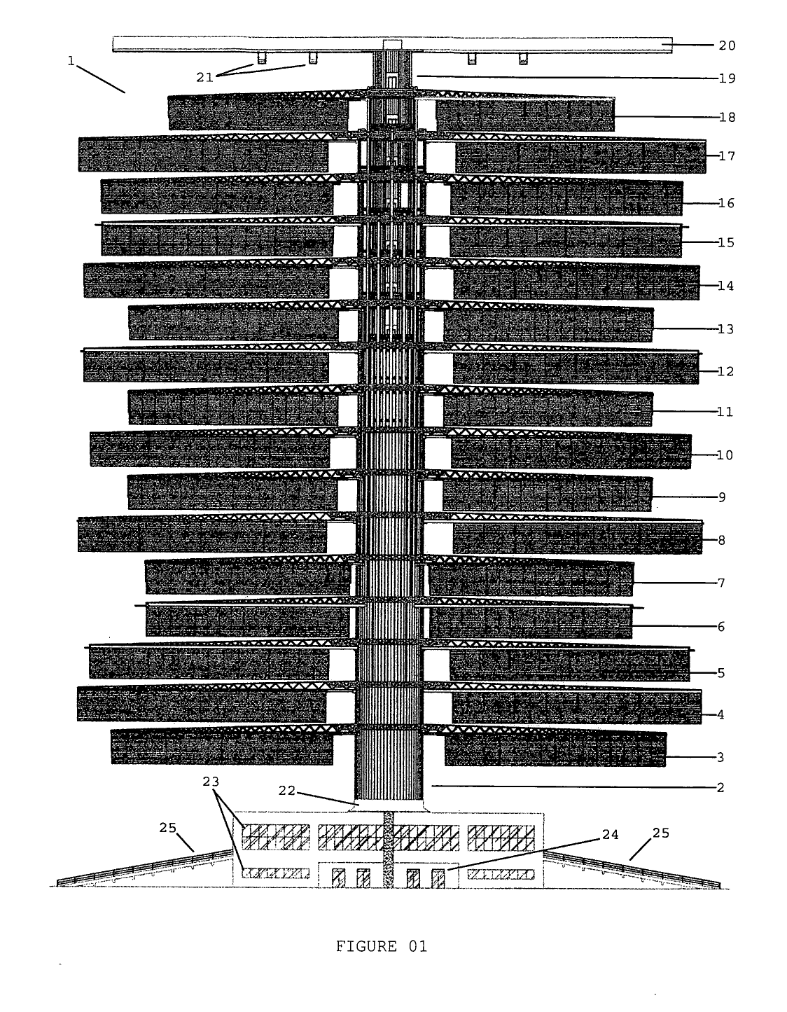

FIG. 02—Side view of the tower, illustrating the full tower, with its various levels and the base building;

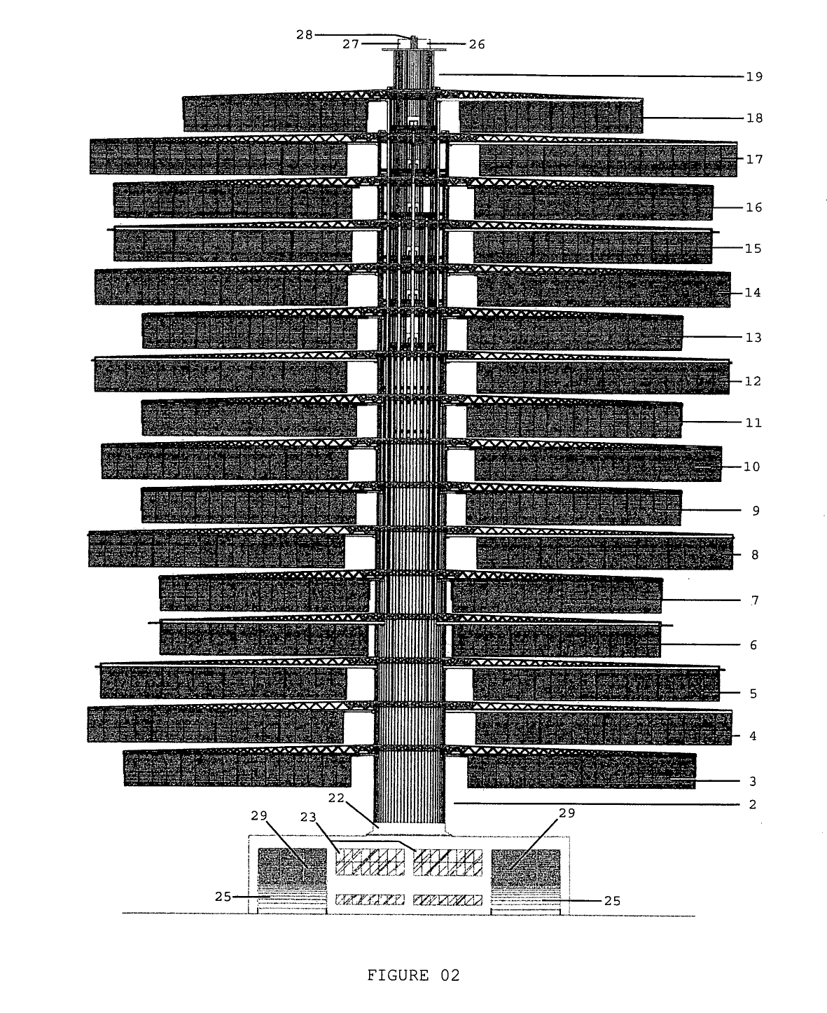

FIG. 03—Front longitudinal section view of the tower, illustrating the internal parts of the tower and building base;

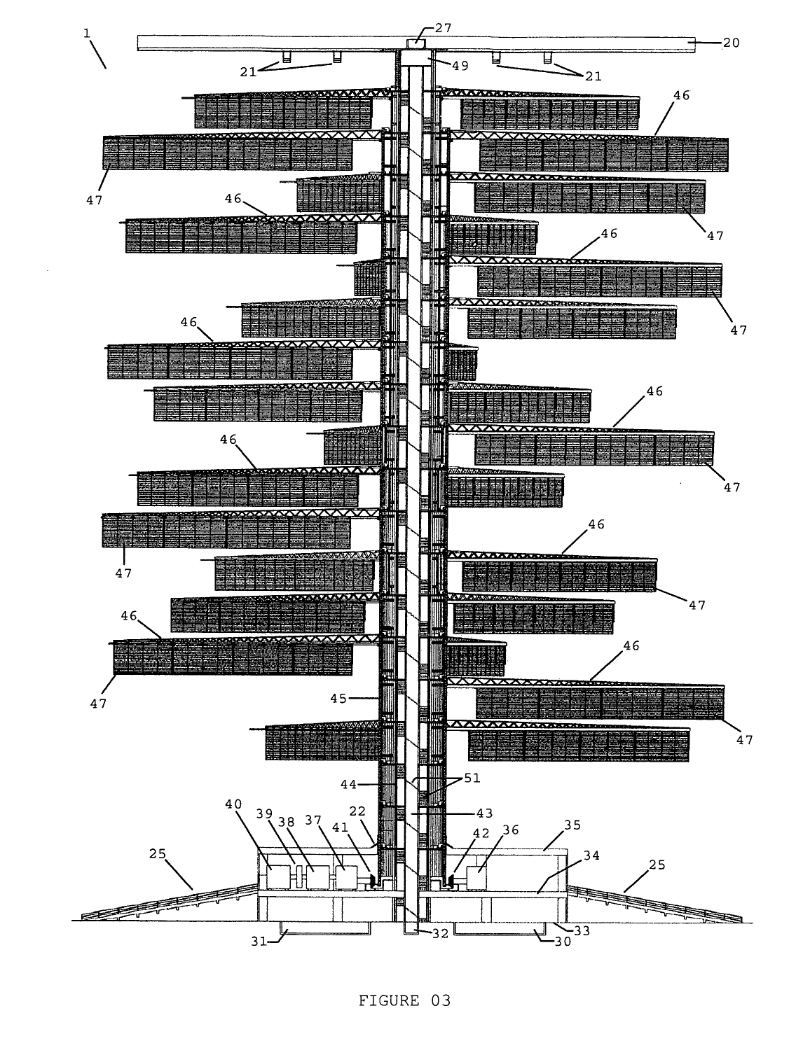

FIG. 04—Side longitudinal section view of the tower, illustrating the internal parts of the tower and building base;

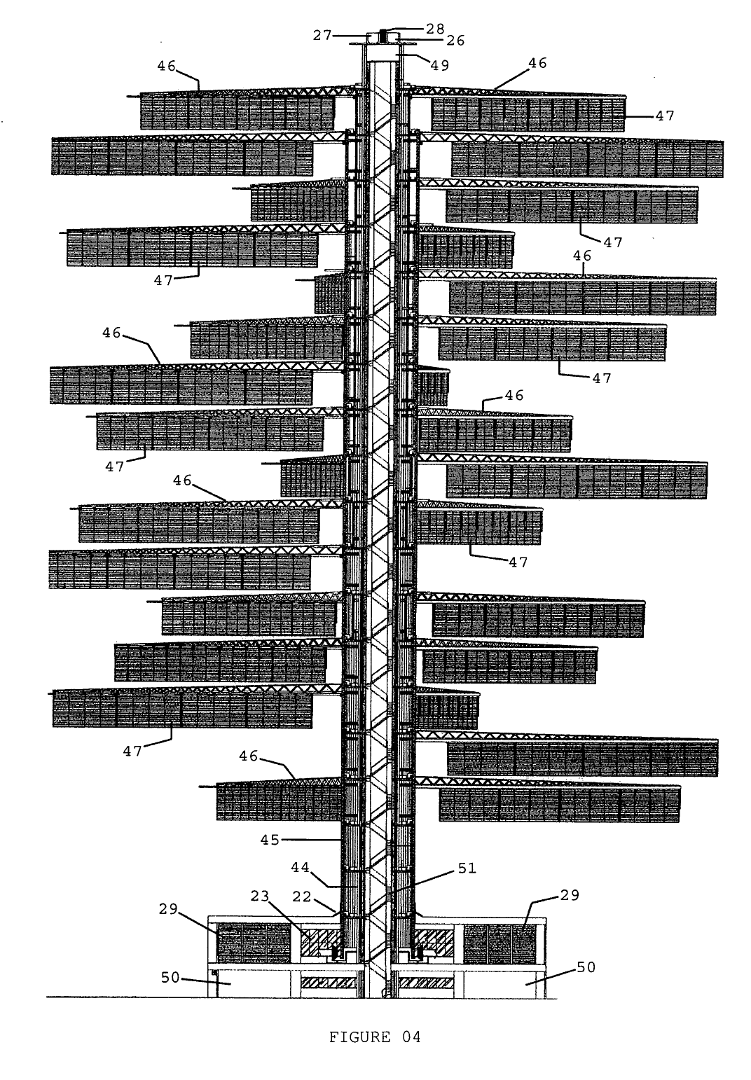

FIG. 05—Front longitudinal section view of the tower, showing the internal parts of the tower and base building and detail “A” of the tower base;

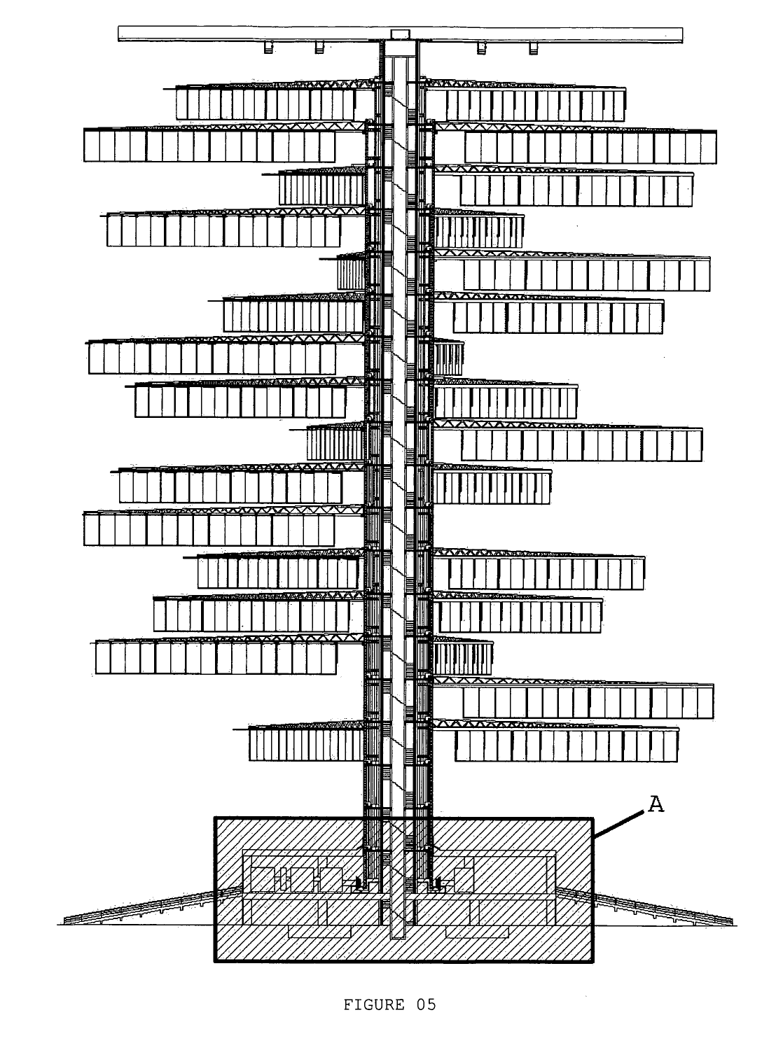

FIG. 06—View of detail “A” of the ground floor, 1^{st} story and 2^{nd} story, in longitudinal cross-section, and detail “B”;

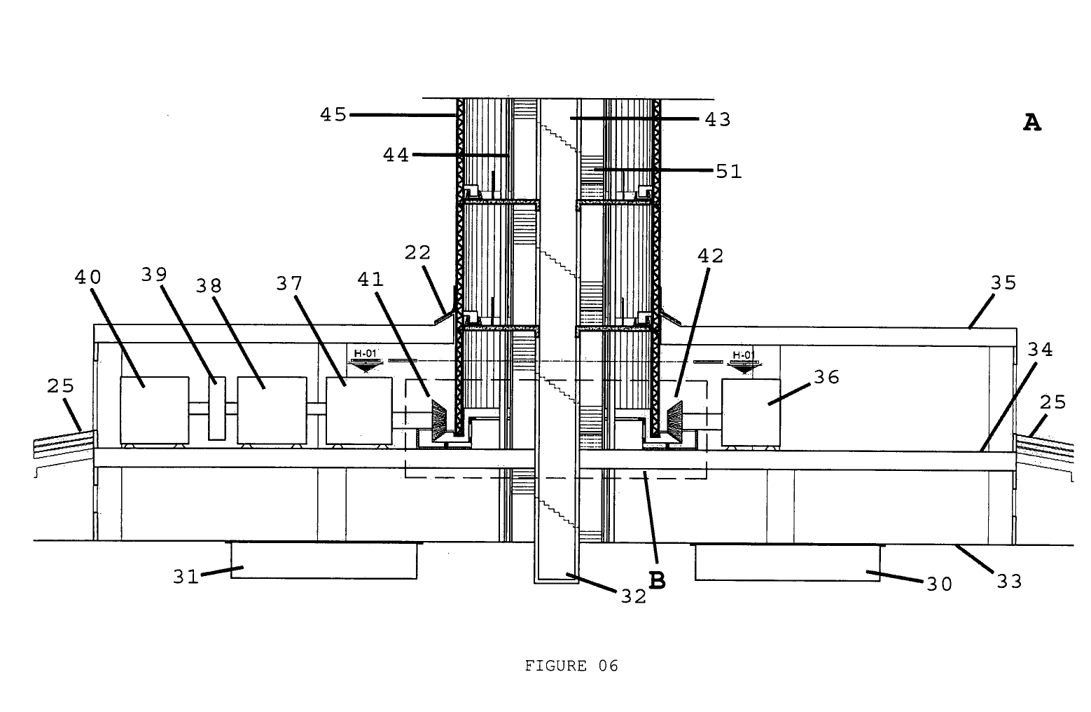

FIG. 07—View of detail “B” of the 1^{st} story, in longitudinal cross-section, illustrating the steering wheel and rack assembly and its support structure;

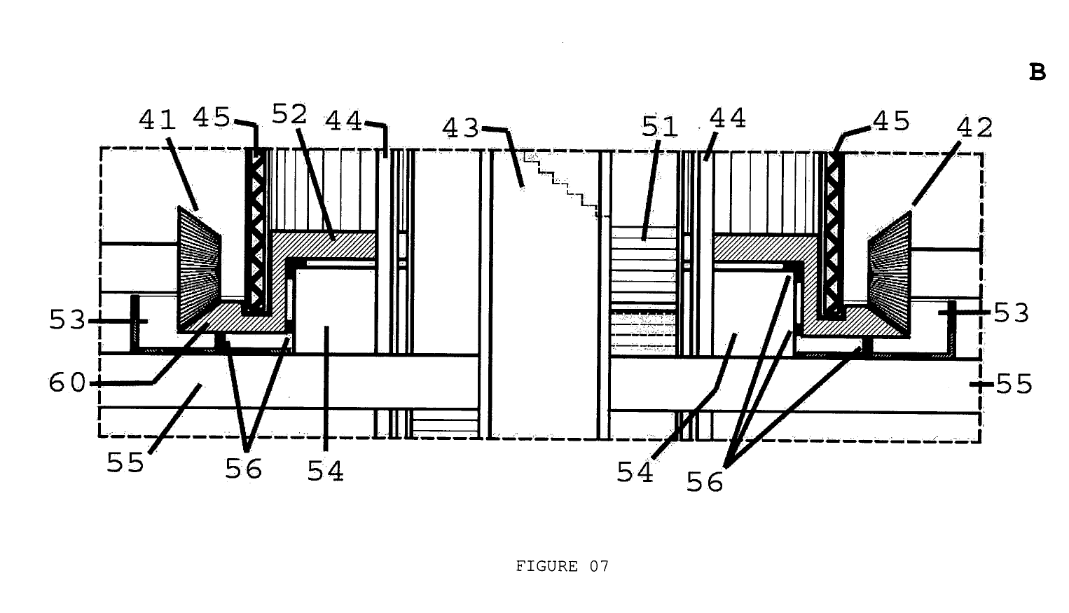

FIG. 08—Front detail view of the steering wheel and rack assembly and means of access to the elevator on the ground floor, illustrating how the metal rotating pillars are supported on the steering wheel and thereby transmit the wind-generated rotation from each of the rotary levels;

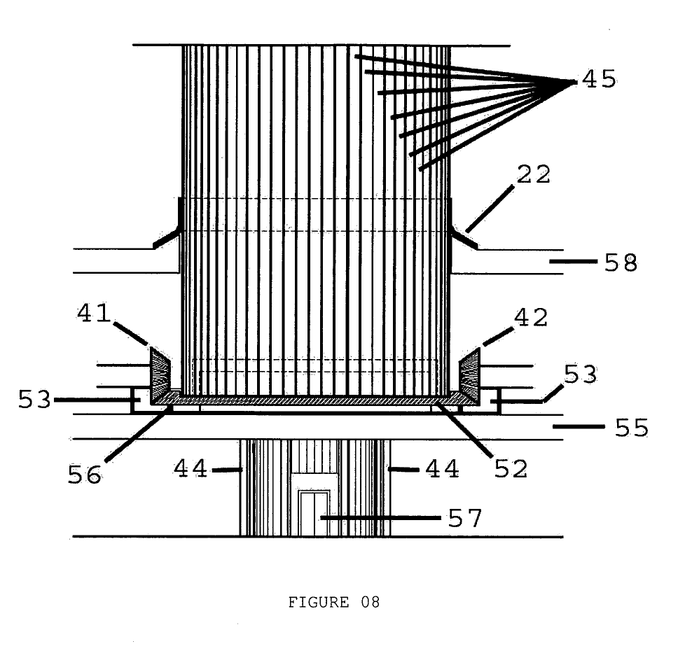

FIG. 09—Top view of the tower's cross-section, as seen in the plan view of the 1^{st} floor;

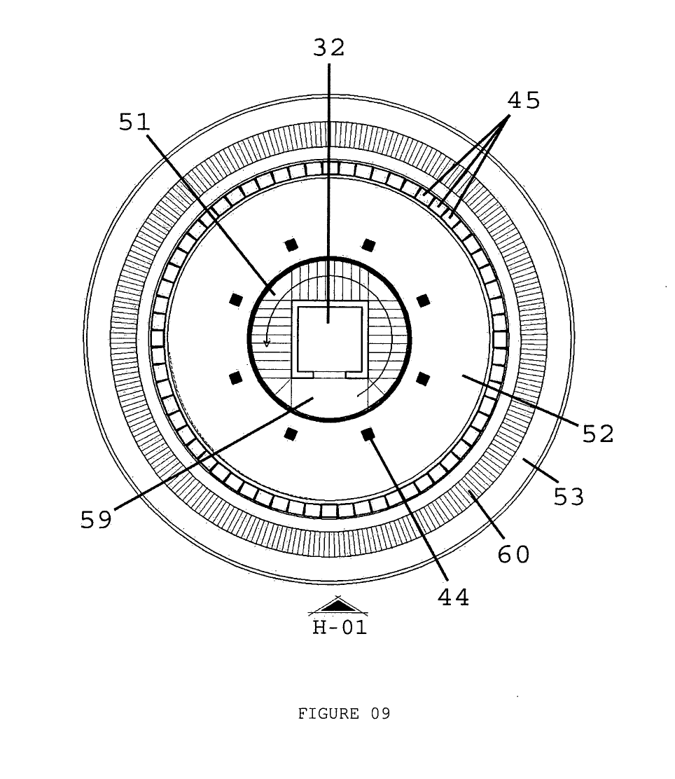

FIG. 10—Front longitudinal section view of the tower with detail “C” of the rotary level sections;

FIG. 11—Detail “C” of the longitudinal section view of the rotary level sections with detail “D” of the rotary metallic pillars supporting the horizontal arms;

FIG. 12—Detail “D” of the rotary metallic pillars supporting the horizontal arms;

FIG. 13—Top view of the ground floor;

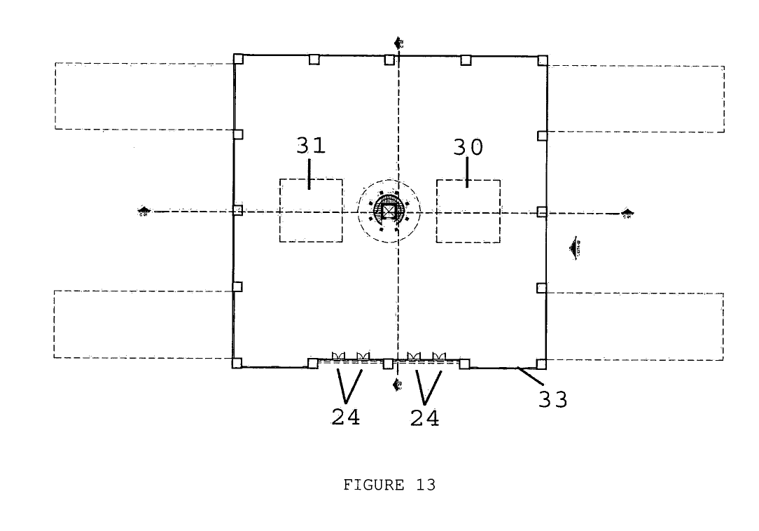

FIG. 14—Top view of the 1^{st} floor;

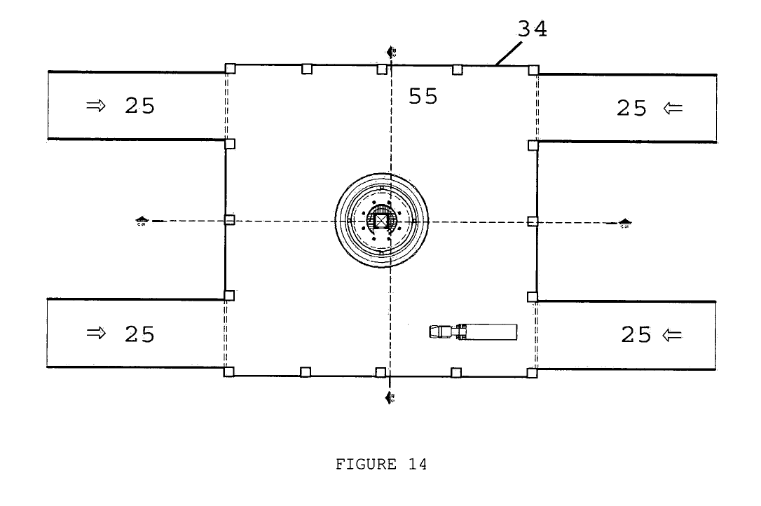

FIG. 15—Top view of the 1^{st} level;

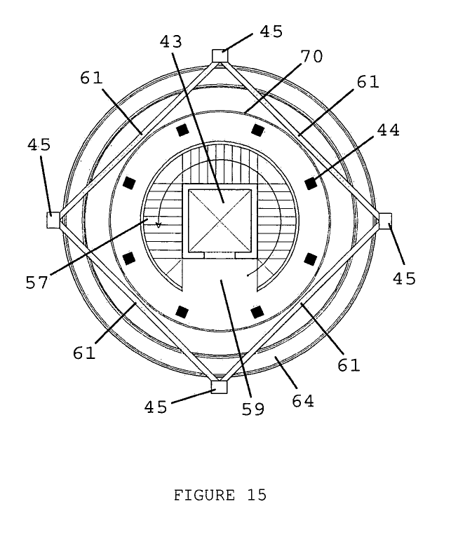

FIG. 16—Top view of the 2^{nd} level;

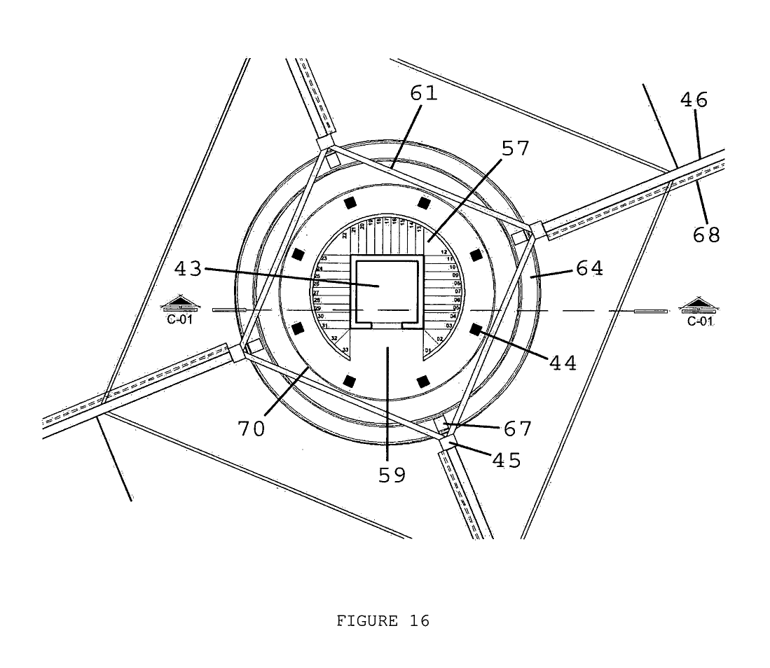

FIG. 17—Top view of the 2^{nd}, 3^{rd}, 4^{th} and 5^{th} rotary levels;

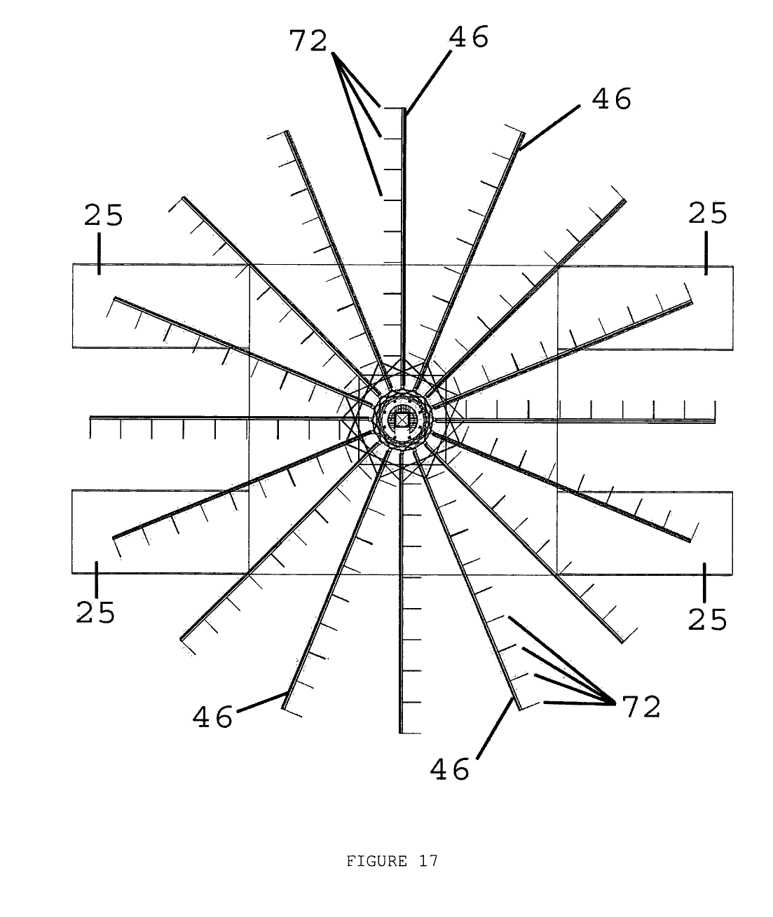

FIG. 18—Perspective view of the 5^{th} rotary level;

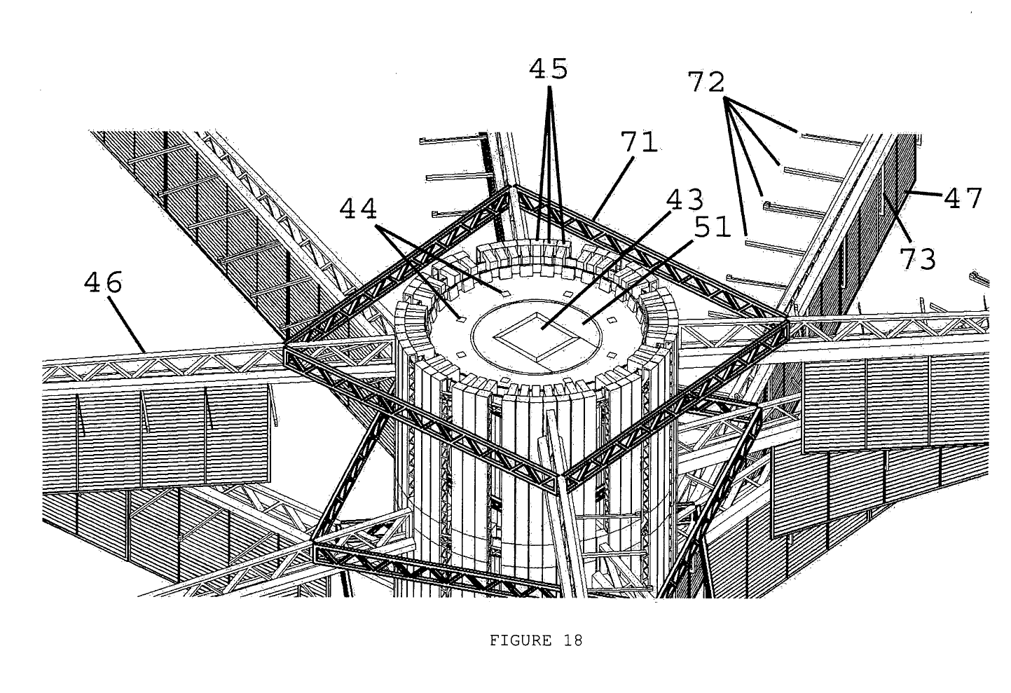

FIG. 19—Detail view of the last level;

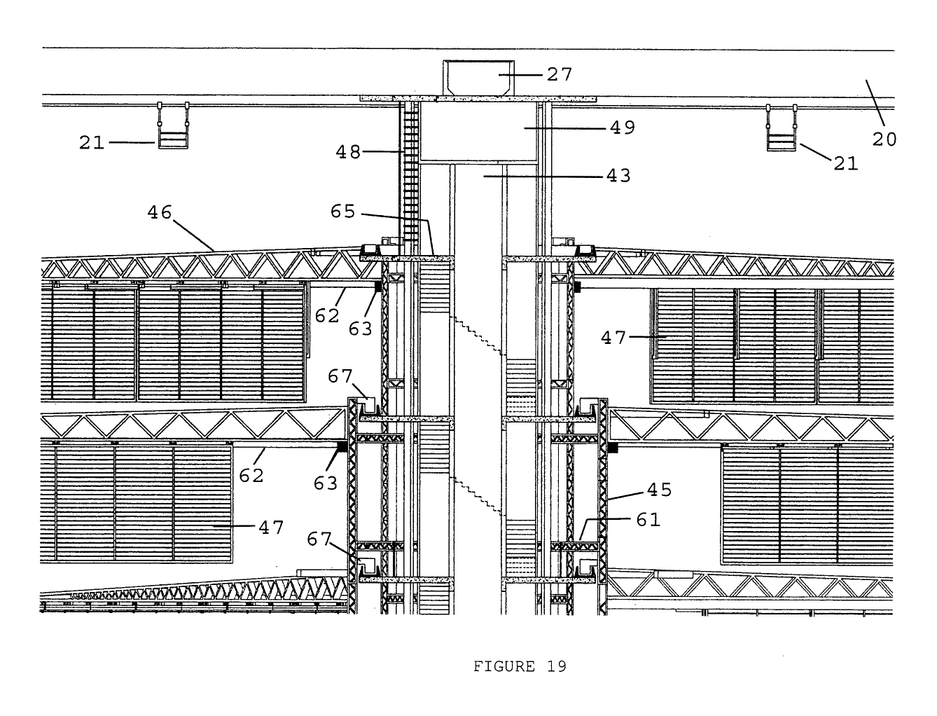

FIG. 20—Top view of the machine room;

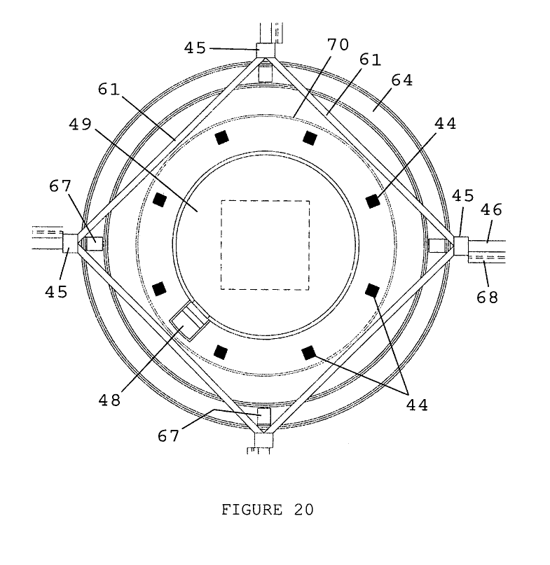

FIG. 21—Top view of the roof;

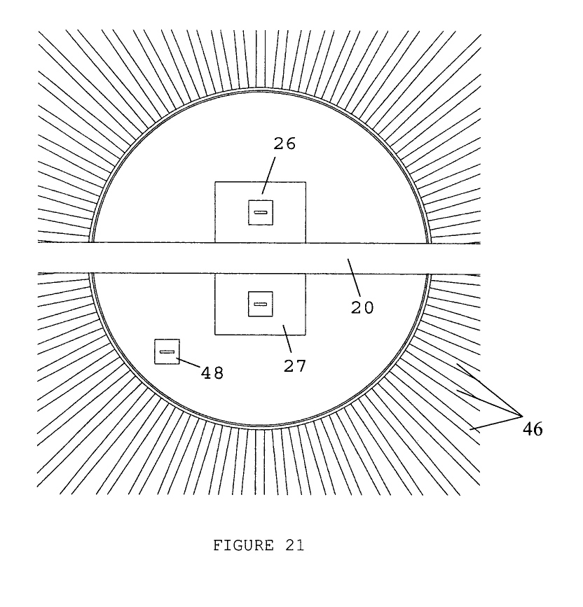

FIG. 22—Detail view of the vertical stopper and horizontal bulkhead fastened to the arm, which simultaneously accompanies the shuttling movement of the aerodynamic panels;

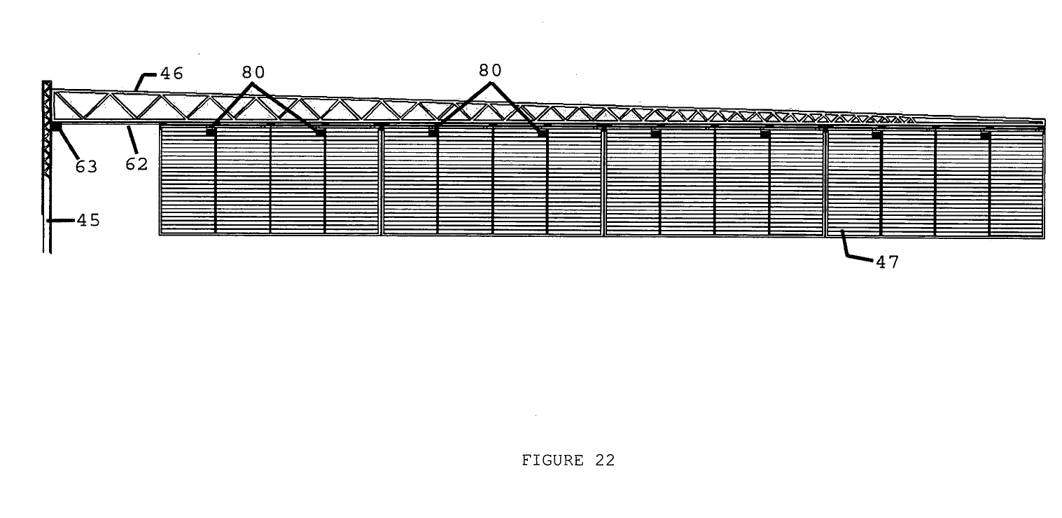

FIG. 23—Detail view of the rotary aerodynamic panel assembly and the stoppers, bulkheads and feathering coils fastened to the arm;

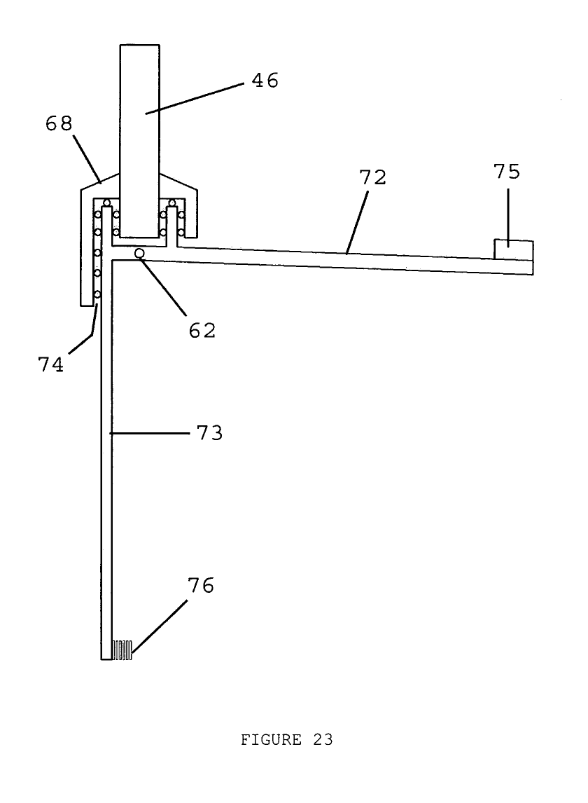

FIG. 24—Detail side view of the aerodynamic panel;

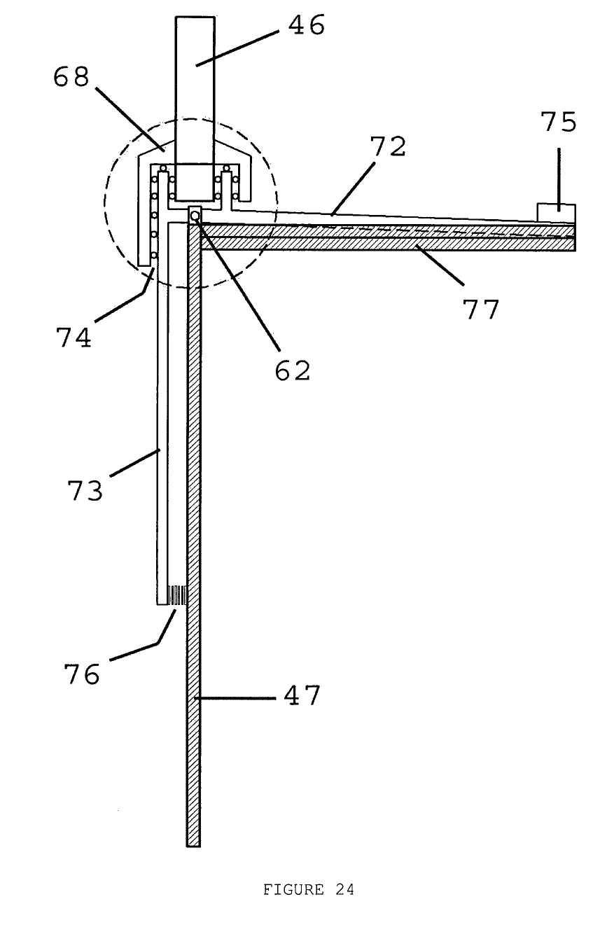

FIG. 25—Perspective view of the rotary aerodynamic panel assembly, stoppers, bulkheads and arm;

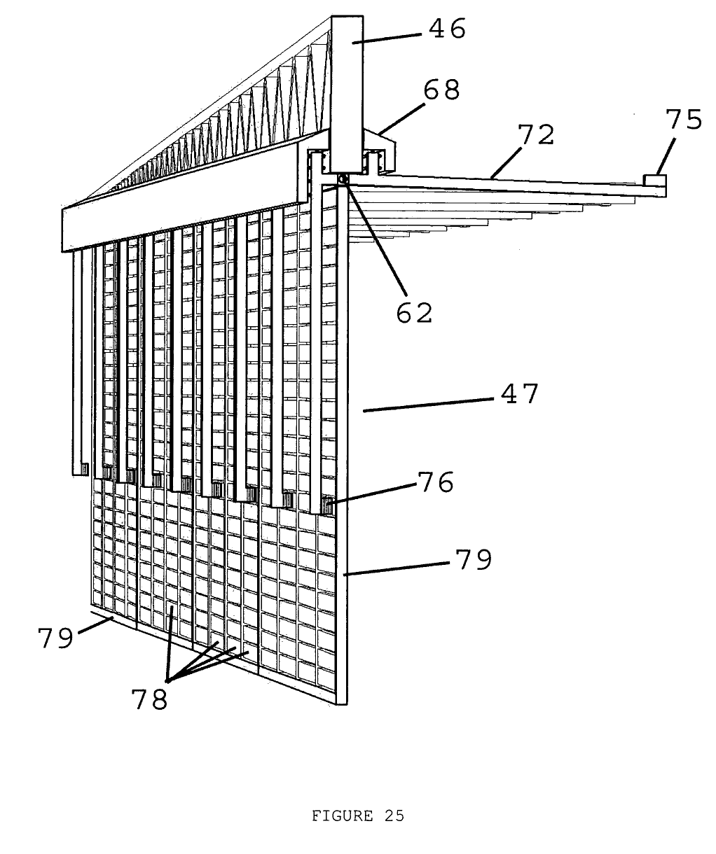

FIG. 26—Graph 1. The graph shows the efficiency with which the wind energy is transformed into rotational mechanical energy considering the total loss of energy from feathering and aerodynamic drag on the panel on the passive side. The vertical axis represents the efficiency, as a percentage, corresponding to the data of the last column of table 1, while the horizontal axis represents wind speed, in meters per second, as shown in the second column of table 1;

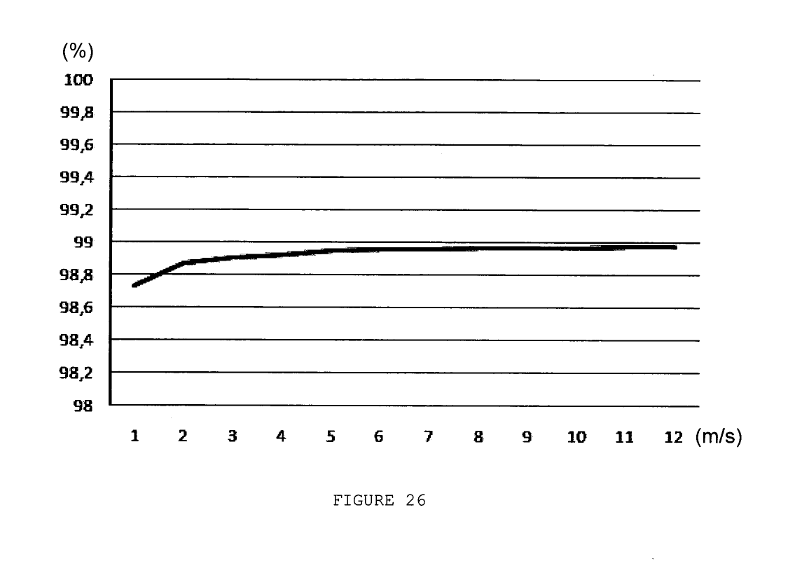

### DETAILED DESCRIPTION OF THE INVENTION

For a better understanding of the present invention, a detailed description is presented below, with reference to the drawings listed above; however, the invention is not limited to the drawings and the embodiment presented below.

The present invention is designed for large-scale electrical power generation and its structure is capable of achieving large dimensions.

The embodiment consists of a wind harnessing system capable of converting wind energy into rotational mechanical energy with 90% efficiency. The system can incorporate several rotary levels with aerodynamic panels, such that a single driveshaft can harness the wind energy available across a huge catchment area. The combined torque produced by the various rotary levels across this huge wind catchment area is transmitted to a single steering wheel and rack assembly. The system is capable of operating even at low wind speeds.

The system is not required to be pointed windward, as regardless of the direction of the wind; the system will rotate in a preset direction.

The system also incorporates devices capable of controlling the revolutions per minute of the steering wheel by extending or retracting the aerodynamic panels, by changing the amount of wind harnessing area, by opening or closing the aerodynamic panel louvers, and by actuating the starter motors and/or combustion engines.

The wind energy conversion tower (1) of the present invention is characterized by its innovative concept, in which a rotary megastructure built of steel or other materials slides horizontally around a vertical mega-tower of reinforced concrete with various levels, and which incorporates means by which these levels can rotate under the force of the wind and transmit this force to a steering wheel and gear assembly, which in turn transmits the torque to various generator sets, transforming wind energy into high-power electrical energy. The tower also incorporates a standard base building with front entry doors (24) on the ground floor and windows (23) on all floors.

The base building also incorporates side windows (23) and ramps (25) leading to the gates (29), allowing trucks and heavy equipment to gain access to the building.

The base building comprises three stories. Access to the elevator (57), the stairs (51), the water pit (30), the oil pit (31) and the elevator pit is gained from the ground floor (33).

The first floor (34) contains the steering wheel (52) and all the generator assemblies connected to it. A generator assembly consists of a generator (38), a combustion engine (40), a clutch (39), a RPM multiplier box (37) and a pinion (41) connected to the box (37) to transmit the rotation of the steering wheel (52). An electric motor (36) coupled to the steering wheel (52) through its pinion (42) is also part of the generator assembly.

The tower (1) of the present invention can incorporate more than one generator assembly, as the tower produces a large amount of torque and can support large loads on its steering wheel (52). The tower's power generation capacity can thus be increased.

The steering wheel (52) has a rack (60) to transmit the rotation to the gearbox pinion (41) from the RPM multiplier box (37) and the electric motor pinion (42) in order to control rotation speed and startup.

The steering wheel (52) is supported on a large circular concrete block (54), rectangular in cross-section, and between this block and the steering wheel (52) there are sliding systems, such as radial bearings (56), allowing the steering wheel (52) to rotate freely. The steering wheel (52) also incorporates a ratchet system that impedes the combustion engine from transmitting rotation to the rotary system of the tower (1).

The generator (38) generates a constant output, with better frequency balance and, consequently, better transient balance thanks to the constant rotation of the tower (1), which is ensured by controlling the distance from the aerodynamic panels (48) to the tower (1) and/or by controlling the wind harnessing area of the aerodynamic panels (47) and/or by opening or closing the louvers (78) of the aerodynamic panels, or by controlling de electric starter motor (36).

The wind energy conversion tower (1) is equipped with a combustion engine (40) to keep the generator (38) running constantly at low wind speeds or during gales or storms, or, alternatively, the power available from an existing non-wind power supply is used instead of the combustion engine (40).

The electric motor (36) removes the system from its state of inertia when starting the converter tower (1) at wind speeds that are insufficient to do so. Said motor (36) also keeps the tower (1) running at a constant speed, when used as a magnetic brake to increase or decrease to load on the steering wheel (52), or acts as a booster to prevent the system from losing speed. The motor is also used to brake the converter (while all the panels are simultaneously flagged) to a stop for maintenance.

Rotation speed sensors are used to monitor the rotation of the steering wheel (52) and provide the parameters required to keep the generator (38) running at a constant speed and delivering an output frequency within the desired limits.

The converter is managed by a control and management system, which manages the power produced by the generator (38) by operating the starter motor(s) (26), the combustion engine(s) (40), the aerodynamic panel shuttling servo motors (63) and/or the aerodynamic panel louver tilting servomotors based on feedback information on instantaneous rotation speed, power output frequency, voltage and current, and wind speed.

Although not illustrated in the figure, current and voltage sensors are provided at the generator (38) output, as well as anemometers with sensors that constantly analyze wind speed and provide this information to the CPU that manages the entire system.

The entire management and control system is located on the tower's 1^{st} floor (34).

The second floor is the top of the building, through the center of which passes the cylindrical tower structure consisting of an internal fixed concrete structure incorporating an elevator shaft (43), a stairs (51), platform slabs at each level (65), concrete pillars (44) that support the different levels of the tower, circular “U” rails (64) fastened to the edges of the platform slabs (65), and protection walls (70). Externally there is a rotating metallic assembly consisting of rotating metallic pillars (45), structural metallic joining arms (61), horizontal truss arms (46) and the aerodynamic panels (47).

To protect the inside of the 1^{st} floor against rain, the 2^{nd} floor has a slab overhang around the walls of the cylindrical tower structure, and around the tower there is a conical metal cover (22) over this overhang.

The lowermost level of the tower (2) has no truss arms (46) or aerodynamic panels (47) to prevent exposure to the transient and non-uniform winds present near ground level, which could affect the performance of the tower (1). The working height of the first level nearest to the ground provided with aerodynamic panels will be determined based on a study of the trade winds in the region; as a rule of thumb, mega-projects will have panels beginning at 100 m from ground level.

From the 2^{nd} level (3) to the 18th level (19) of the tower (1), the fixed and rotating structures are practically the same, except for the 18th level (19), the top of the tower (1), which houses the elevator machine room (49) and has a structure on top for tower maintenance consisting of a rectangular cross-section beam supporting a monorail (20) having the same width as the horizontal truss arms (46). The suspended chairs and work platforms (21) can traverse the entire length of the truss arms (46) and rise and descend along the entire height of the tower (1) to service all the moving elements of the tower. The water tank (26) and oil tank (27) are also situated on the flat roof of the 18th level. Access to these tanks is gained by means of a ladder (48) located on the side of the uppermost level.

The water tank (26) supplies potable water to the base building (ground floor and 1st floor) and the fire main.

The oil tank feeds oil to the rails (64) of each level, allowing the supports (67) of the rotating pillars to slide easily. The oil tank also feeds the steering wheel (52) oil box (53), ensuring that the steering wheel's rack (60) and the pinions of the starter motor (42) and RPM multiplier box (41) run smoothly.

A set of pumps are used to pump water and oil from the water pit (30) and oil pit (31) to the corresponding tanks on the roof of the tower. These pumps are powered by the tower itself.

The structure of the levels described above consists of a fixed concrete part and a rotating metallic part.

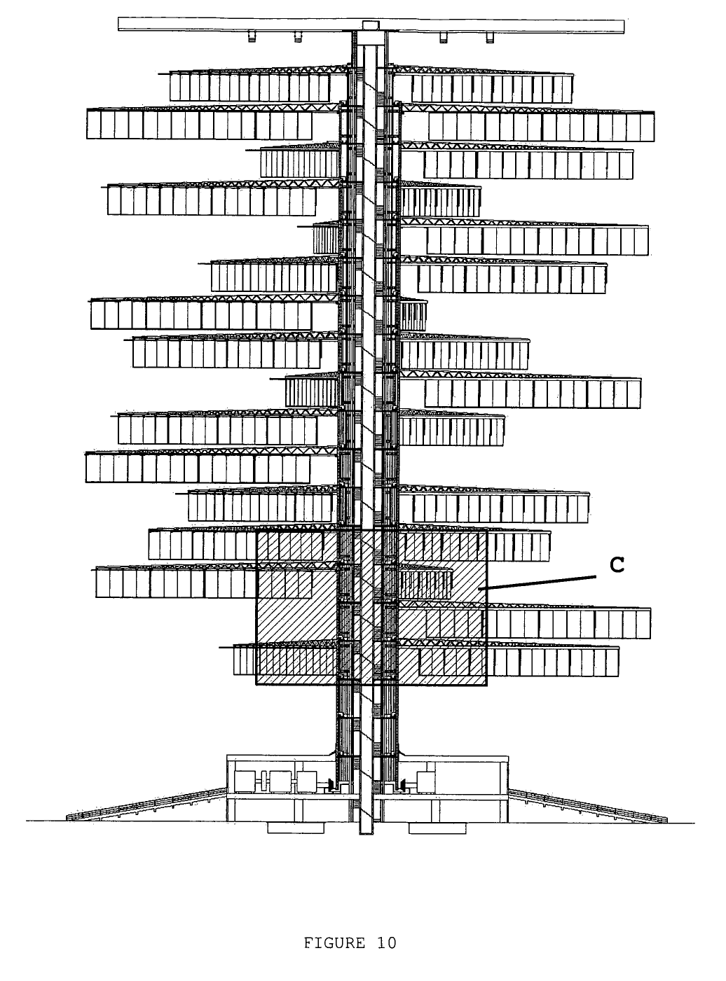

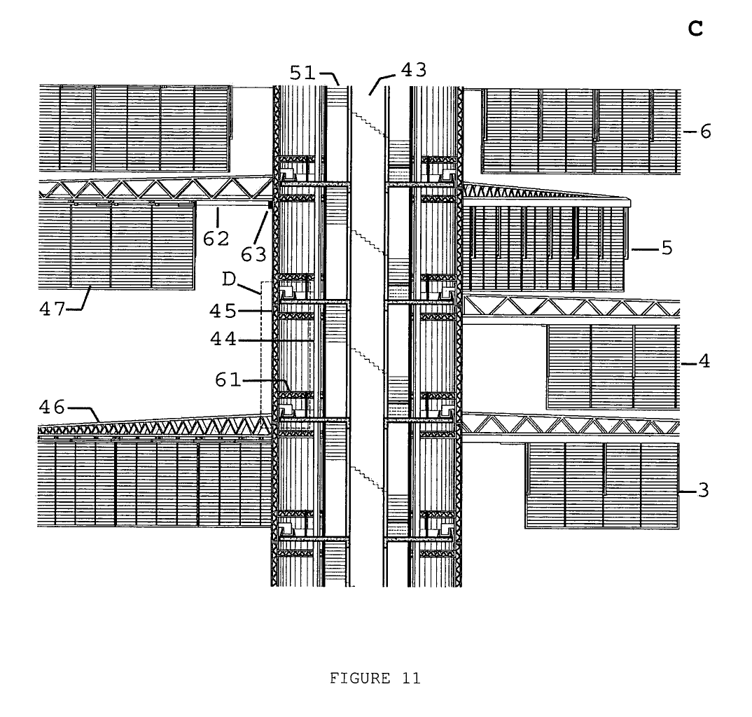

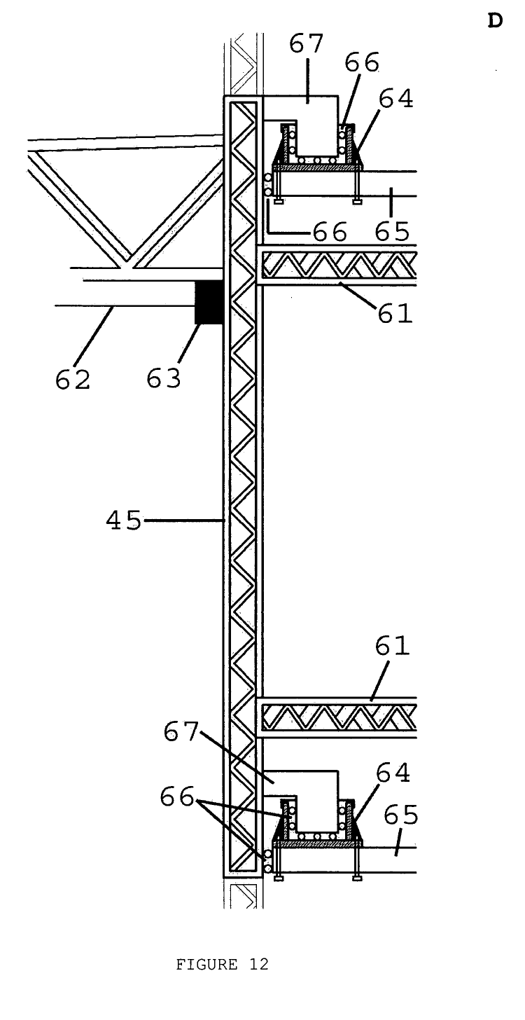

These structures are well illustrated in details “C” and “D” of FIGS. 10, 11 and 12.

The levels form cylindrical sections comprising, from the inside outwards, an elevator shaft (43); a stairs (51); structural concrete pillars (44) that are the responsible for the structure of the tower; a protection wall (70); a slab (67) that forms the floor of each level, said platform slab being circular in shape, supported by the concrete pillars (44) and having a substantial overhang; and a circular “U” rail (64) around the edge of the slab. These are the fixed elements of each level. The rotating elements consist of rotating metallic pillars (45), which are interconnected by two levels of four metallic beams (61) providing stability to the assembly; “L” brackets (67) on the rotating metallic pillars, which hang on the rails (64) by means of radial bearings (66), allowing the rotating elements of each level to rotate freely; horizontal truss arms (46); and aerodynamic panels (47) fastened to them.

Every level has four rotating pillars (45) descending to the steering wheel (52) and transmitting the rotation of each level to this steering wheel (52).

Every level of the rotary assembly is staggered in relation to the lower-next level such that there is an equally spaced distribution around the entire 360° circle, thereby ensuring that the loads of the horizontal arms (46) are evenly distributed across the height and circumference of the tower (1) and that the wind energy is utilized with utmost efficiency.

To maintain the staggered angles between adjacent levels, a truss beam connection is made between one of the pillars (45) of the upper level and one of the pillars (45) of the lower level. This prevents the staggered angles of the different panel (47) levels from being lost.

The self supported horizontal arms (46) have a truss structure and are joined to the tower (1) through one of the rotating metallic pillars (45).

The horizontal arms (46) are inter-connected by metallic beams (71), providing greater stiffness and stability to the arm assembly of each level, and may also be braced by wire rope cables fastened to other points.

Rails (68) fastened to the horizontal truss arms (46) support the drive-side stoppers (73) and the moving bulkheads (72) and allow them to shuttle along the entire extension of the arm (46).

The aerodynamic panel shuttling servomotors (63) drive the horizontal shafts (62) supporting the aerodynamic panels (47), which act as lead screws that extend or retract the aerodynamic panels (47), the drive side stoppers (73) and the bulkheads (72) as needed to control the angular speed of the tower.

The drive side stoppers (73) and bulkheads (72) slide on the rails (68) by means of thrust bearings (74) and the aerodynamic panels (47) slide on the horizontal shafts supported by the arm (46) and fastened to the shuttling servomotor.

The aerodynamic panels (47) can be made of metal, plastic, synthetic fibers or weather resistant light fabrics, or any other material having the properties required to withstand the force of the wind.

If heavier materials are used to build the aerodynamic panels (47), the system must incorporate counterweights such that the panels continue to be light in relation to the force of the wind for feathering purposes, ensuring that there will be no loss of efficiency.

The aerodynamic panels (47) have a rigid frame made of a light material, such as metal, metal alloy, aluminum, carbon fiber, iron, steel or plastic, which stiffens the panels and maintains their flatness under the force of the wind.

The aerodynamic panel (47) frames incorporate louvers (rigid plates with tilting mechanisms) driven by servomotors, which tilt the louvers open or closed to decrease or increase wind pressure as necessary (by increasing or reducing the wind harnessing area) or inversely by increasing the thrust in the case of a fall in wind speed on the aerodynamic panels.

The purpose of said system is to decrease the wind energy harnessing area, as another means of controlling the rotation speed and power of the wind energy converter tower.

During gales, storms or when the tower must be stopped for maintenance, solenoids (75) fastened to the ends of the bulkheads (72) are energized, creating a magnetic field capable of keeping the aerodynamic panels (47) in their feathering (horizontal) position, preventing damage to the panels (47) and tower (1).

The drive side stoppers (79) and bulkheads (72) incorporate shock absorbers (76) that absorb the impact of the aerodynamic panels (47) to prevent damage.

The aerodynamic panels (47) are connected to the threaded horizontal shafts (5) by means of threaded hinges, which enable the aerodynamic plates (47) to traverse in both directions on the servomotor-driven shafts and to feather out of the wind when moving upwind, held by the bulkheads, while remaining vertical when moving downwind, held by the drive side stoppers, causing the entire rotary assembly to rotate.

The aerodynamic panels are square or rectangular and have a negligible thickness, allowing them to feather out of the wind and return to their vertical position, where they harness the wind power that drives the rotary assembly, the steering wheel and rack assembly, and ultimately the generation equipment. This way, the wind-driven horizontal rotation of the panels is transmitted to the generator.

1-42. (canceled)

43. An eolic converter tower, wherein various levels of rotary structures of steel or other materials slides horizontally around a vertical structure consisting of a reinforced concrete tower working together or independently rotating under the force of the wind and transmit this force to at least one steering wheel and at least one rack assembly, which in turn transmits the force to a plurality of generator sets located in the base of the converter or distributed in each rotary level, transforming wind energy into high-power electric energy; wherein the wind harnessing system is capable of transforming wind energy into rotational mechanical energy with 90% efficiency; wherein said system incorporates a set of devices capable of controlling the revolutions per minute of the steering wheel by extending or retracting the aerodynamic panels, opening or closing the aerodynamic panel louvers to increase or decrease the wind harnessing area, and by operating the starter motors and/or combustion engines.

44. The eolic converter tower of claim 43, further comprising a base building and a cylindrical structure supported on said base building.

45. The eolic converter tower of claim 44, wherein the base building comprises three floors—a ground floor (33), a first floor, and a second floor.

46. The eolic converter tower of claim 45, wherein the ground floor (33) incorporates entry doors (24) and windows (23), means of access to the elevator (57), means of access to the stairs (51), means of access to a water pit (30), means of access to an oil pit (31) and means of access to the elevator pit (32).

47. The eolic converter tower of claim 43, wherein the generator assembly consists of a generator (38), a combustion engine (40), a clutch (39), a RPM multiplier box (37) and a pinion (41) connected to the box (37) to transmit the rotation of the steering wheel (52), and an electric motor (36) coupled to the steering wheel (52) through its pinion (42).

48. The eolic converter tower of claim 43, wherein the steering wheel (52) has a rack (60) to transmit rotation to the gearbox pinion (41) and the electric motor pinion (42) in order to control rotation speed and startup.

49. The eolic converter tower of claim 43, wherein the steering wheel (52) is supported on a large circular concrete block, rectangular in cross-section (54), and wherein between this block and the steering wheel (52) there are sliding systems allowing the steering wheel (52) to rotate freely.

50. The eolic converter tower of claim 49, wherein the sliding systems are radial bearings (56).

51. The eolic converter tower of claim 48, wherein the steering wheel (52) incorporates a ratchet system that impedes the combustion engine from transmitting rotation to the rotary system of the tower (1).

52. The eolic converter tower of claim 48, wherein the generator (38) generates a power output with constant voltage, balanced frequency and no transients thanks to the constant rotation of the tower (1), which is ensured by controlling the distance from the aerodynamic panels (47) to the tower (1), and/or by controlling the wind harnessing area of the aerodynamic panels (47), and/or by opening or closing the louvers (78) of the aerodynamic panels, and/or by controlling the electric starter motor (36), and by monitoring the rotation speed of the steering wheel (52) by means of rotation speed sensors, which provide the parameters required to keep the generator (38) running at a constant rotation speed, ensuring that the power output frequency is within desirable limits.

53. The eolic converter tower of claim 48, wherein the generator assembly (6) includes a combustion engine (40) to keep the generator (38) running at a constant speed at low wind speeds or during gales or storms, or, alternatively, the power available from an existing none wind power supply is used instead of the combustion engine (40).

54. The eolic converter tower of claim 48, wherein the generator assembly includes an electric motor (36) to remove this system from its state of inertia when starting the converter tower (1) at wind speeds that are insufficient to do so. Said motor (36) also keeps the tower (1) running at constant speed, when used as a magnetic brake to increase or decrease to load on the steering wheel (52), or acts as a booster to prevent the system from losing speed.

55. The eolic converter tower of claim 54, wherein the electric motor (36) keeps the tower (1) running at constant speed, when used as a magnetic brake to increase or decrease to load on the steering wheel (52) or acts as a booster to prevent the system from losing speed.

56. The eolic converter tower of claim 54, wherein the electric motor (36) is used to brake the converter to a stop for maintenance

57. The eolic converter tower of claim 43, wherein a tower (I) control and management system manages and maintains the power produced by the generator (38) at constant values by operating the starter motor(s) (36), the combustion engine(s) (40), the aerodynamic panel shuttling servo motors (63) and/or the aerodynamic panel louver tilting servomotors, based on feedback information on instantaneous rotation speed, power output frequency, voltage and current, and wind speed.

58. The eolic converter tower of claim 57, wherein the tower (1) control and management system incorporates current and voltage sensors at the generator (38) output, anemometers with sensors that constantly analyze wind speed and a CPU.

59. The eolic converter tower of claim 43, wherein the uppermost or top level (19) incorporates an elevator machine room (49), a top-mounted structure for tower maintenance, a water tank (26), an oil tank (27) and a ladder (48) on the side of the uppermost level, providing access to these tanks.

60. The eolic converter tower of claim 59, wherein the structure for tower maintenance consists of a rectangular section beam having the same width as the horizontal truss arms (46), supporting a monorail (20) on which the maintenance chairs and work platforms (21) can traverse the entire length of the truss arms (46) and rise and descend along the entire height of the tower (1) to service all the moving elements of the tower. The roof of the uppermost level also holds the water tank (26) and oil tank (27).

61. The eolic converter tower of claim 59, wherein the water tank (26) supplies potable water to the base building (ground floor and first floor) and the fire main.

62. The eolic converter tower of claim 59, wherein the oil tank (27) feeds oil to the rails (64) of each level, allowing the brackets (67) supporting the rotating pillars to slide easily, and the steering wheel (52) oil box (53), ensuring that the steering wheel's rack (60) and the pinions of the starter motor (42) and RPM multiplier box (41) run smoothly.

63. The eolic converter tower of claim 59, wherein a set of pumps powered by the tower itself pump water and oil from the water pit (30) and oil pit (31) to the corresponding tanks (26) and (27).

64. The eolic converter tower of claim 43, wherein the fixed part of the physical structure of the levels has cylindrical sections comprising, from the inside outwards, an elevator shaft (43), a stairs (51), structural concrete pillars (44), a protection wall (70); a slab (67) that forms the floor of each level, said platform slab being circular in shape, supported by the concrete pillars (44) and having a substantial overhang, and a circular “U” rail (64) around the edge of the slab.

65. The eolic converter tower of claim 43, wherein the physical structure of the levels comprises rotating metallic pillars (45), which are interconnected by two levels of four metallic beams (61) providing stability to the assembly, “L” brackets (67) on the rotating metallic pillars, which are supported on the rails (64) by means of radial bearings (66), allowing the rotating elements of each level to rotate freely; horizontal truss arms (46), and the aerodynamic panels (47) fastened to them.

66. The eolic converter tower of claim 43, wherein each level has 4 rotating pillars (45) extending downwards to the steering wheel (52) and transmitting the rotation from each level to this steering wheel (52).

67. The eolic converter tower of claim 43, wherein every level of the rotary assembly is staggered in relation to the lower-next level such that there is an equally spaced distribution around the entire 360° circle, thereby ensuring that the loads of the horizontal arms (46) are evenly distributed across the height and circumference of the tower (1) and that the wind energy is harnessed with utmost efficiency, and wherein the staggered angles between adjacent levels are maintained by a truss beam connection between one of the pillars (45) of the upper level and one of the pillars (45) of the lower level. This prevents the staggered angles of the different panel (47) levels from being lost.

68. The eolic converter tower of claim 43, wherein the self supported horizontal arms (46) have a truss structure and are connected to the tower (1) through the rotating metallic pillars (45).

69. The eolic converter tower of claim 68, wherein the horizontal arms (46) are inter-connected by metallic beams (71), providing greater stiffness and stability to the arm assembly of each level, and may also be braced by wire rope cables fastened to other points.

70. The eolic converter tower of claim 69, wherein rails (68) fastened to the horizontal truss arms (46) support drive-side stoppers (73) and moving bulkheads (72) and allow them to traverse the entire length of the arm (46).

71. The eolic converter tower of claim 68, wherein the horizontal truss arms (46) incorporate aerodynamic panel shuttling servomotors (63) that drive the horizontal shafts (62) supporting the aerodynamic panels (47), which act as lead screws that extend or retract the aerodynamic panels (47), the drive side stoppers (73) and the bulkheads (72) as needed to control the angular speed of the tower (1).

72. The eolic converter tower of claim 70, wherein the drive side stoppers (73) and bulkheads (72) slide on the rails (68) by means of thrust bearings (74) and the aerodynamic panels (47) slide on the horizontal shafts supported by the arms (46) and fastened to the aerodynamic panel shuttling servomotors.

73. The eolic converter tower of claim 43, wherein the aerodynamic panels (47) may be made of metal, plastic, synthetic fibers or weather resistant light fabrics, or any other material having the properties required to withstand the force of the wind.

74. The eolic converter tower of claim 43, wherein, if heavier materials are used to build the aerodynamic panels (47), the system incorporates counterweights such that the panels continue to be light in relation to the force of the wind for feathering purposes, ensuring that there will be no loss of harnessing efficiency.

75. The eolic converter tower of claim 43, wherein the aerodynamic panel (47) frames have the louvers (78) (rigid plates with tilting mechanisms) driven by servomotors, which tilt the louvers open or closed to decrease or increase wind pressure as necessary (by increasing or reducing the wind harnessing area).

76. The eolic converter tower of claim 43, wherein the aerodynamic panels (47) incorporate solenoids (75) fastened to the ends of the bulkheads (72), which are energized during gales, storms or when the tower must be stopped for maintenance, creating a magnetic field capable of keeping the aerodynamic panels (47) in their feathering (horizontal) position, thereby preventing damage to the panels (47) and tower (1).

77. The eolic converter tower of claim 43, wherein the drive side stoppers (79) and bulkheads (72) of the aerodynamic panels incorporate shock absorbers (76) that absorb the impact of the aerodynamic panels (47) to prevent damage.

78. The eolic converter tower of claim 43, wherein the aerodynamic panels (47) are connected to threaded horizontal shafts (5) by means of threaded hinges, which enable the aerodynamic plates (47) to traverse in both directions on the servomotor-driven shafts and to feather out of the wind when moving upwind, held by the bulkheads, while remaining vertical when moving downwind, held by the drive side stoppers, causing the entire rotary assembly to rotate.
